(19) United States
(12) Patent Application Publication
(10) Pub. No.: US 2007/0183921 A1
(43) Pub. Date: Aug. 9, 2007

(54) Bulk solidified quenched material and process for producing the same

(75) Inventors: Yasubumi Furuya, Miyagi (JP); Teiko Okazaki, Aomori (JP); Chihiro Saito, Aomori (JP); Masaki Yokoyama, Aomori (JP); Mamoru Oomori, Miyagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN SCIENCE AND TECHNOLOGY AGENCY, KAWAGUCHI-SHI (JP)

(21) Appl. No.: 10/598,767

(22) PCT Filed: Oct. 8, 2004
(86) PCT No.: PCT/JP04/14963

§ 371 Date: Sep. 11, 2006

(30) Foreign Application Priority Data
Mar. 11, 2004 (JP) 2004-069787

(51) Int. Cl. B22F 3/105; C22C 14/00; H01F 1/08

(52) U.S. Cl. 419/56; 148/121; 148/402; 148/306

(57) ABSTRACT

[Object] A bulk material which is suitably used as a material for actuator and sensor elements is formed from a Fe—Ga base magnetoresistive alloy and a Ti—Ni base shape memory alloy taking advantage of crystal miniaturization and anisotropy as well as reduction of precipitates (equilibrium state in state diagram) and non-equilibrium phases peculiar to liquid rapidly solidified materials, and the performance of the material is enhanced by a production method thereof which has cost advantage over a melt method.

[Construction] A rapidly solidified material having a particular rapidly solidified texture of a Fe—Ga magnetostrictive alloy or a TiNi-based shape-memory alloy and properties derived therefrom is formed into slices which are laminated to each other in a die, or is formed into a powder or chops which are filled in the die. Subsequently, spark plasma sintering is performed so that bonds between the slices, grains of the powder, or the chops are formed at a high density to form a bulk alloy, followed by annealing whenever necessary, so that the properties of the alloy are improved.

### TECHNICAL FIELD

The present invention relates to a rapidly solidified material consolidated into a bulk form and a method for producing the same, and more particularly, relates to a giant magnetostrictive alloy or a shape-memory alloy and a method for producing the same, the alloy being a bulk rapidly solidified material which is produced by a liquid rapid solidification method and a spark plasma sintering method and which is used as a material for sensor and actuator elements.

### BACKGROUND ART

By using a liquid rapid solidification method, various amorphous, fine crystalline, and polycrystalline alloy-based materials have been developed. Functional materials, such as a shape-memory alloy, in the form of a thin belt, a thin wire, and a powder can be formed by a liquid rapid solidification method (Patent Documents 1 and 2).

As for an iron-based magnetic shape-memory alloy, one (Furuya) of the inventors of the present invention found a giant magnetostrictive effect by using a liquid rapid solidification method which is equivalent to the level of Terfenol-D known as a giant magnetostrictive material. This new magnetostrictive material is a practical polycrystalline material having a particular crystal controlled texture which is fine and has strong directionality peculiar to a rapidly solidified material, and a patent application relating to a polycrystalline Fe—Pd-based and a Fe—Pt-based alloy was filed (Patent Document 3). In addition, the inventors of the present invention reported properties of a thin belt-shaped sample of a Fe-15 at % Ga alloy which was annealed for a short period of time (1,173 K for 0.5 hour) (Non-Patent Document 3).

Furthermore, it was also found that when a NiCoGa, a CoNiGa-based alloy (Patent Document 4) and a Fe—Ga-based alloy (Patent Document 5) are processed at a certain rapid cooling rate, a fine columnar crystal texture having significantly strong crystalline anisotropy can be formed, and that the material thus controlled also has ductility and can induce a magnetostrictive phenomenon 6 to 10 times or more that of a conventional randomly oriented crystalline material.

It has been disclosed that in a rapidly solidified shape-memory alloy, because of crystal miniaturization having a nano- to a micron-size scale and columnar crystal (anisotropy) formation peculiar to a rapidly solidified material, a shape-memory alloy composition (such as a thin wire (fiber) and a thin belt (ribbon) made of Ti₅₀Ni₅₀₋ₓCuₓ (x≧8 atomic percent)) can be produced which could not been produced by a conventional melting and rolling process, and that functional performances such as ductility, strength, and shape-memory effect can be improved (Non-Patent Documents 1 and 2).

In research relating to enhancement of performance of a Ti—Ni-based shape-memory alloy (Non-Patent Document 5), the result has been reported by Kajiwara et al. which was obtained when a Ti-rich Ti—Ni-based thin film (Ti₅₄Ni₄₀Cu₆ (atomic percent)) approximately in an amorphous state formed by a sputtering deposition method is annealed at a low temperature compared to that of a conventional case.

According to this technical paper, there have been reported that non-equilibrium phases such as Ti₂Ni and TiNi₃ having a highly dense tetragonal structure with a bct (body-centered tetragonal) lattice are precipitated on the {100} plane of a TiNiB₂ mother phase and form two types of distributions (arrangements) depending on a slight difference in annealing temperature; a uniform distribution is obtained when annealing is performed in the vicinity of an amorphous crystallization temperature (Tc), and a texture is formed on boundaries of nanocrystals when annealing is performed at a temperature slightly below the Tc; and the shape-memory performance is enhanced by the change in precipitation mode.

In addition, there has been reported that also as for a Ti-rich Ti—Ni—Cu thin film, the shape-recovery performance thereof is further enhanced when bct precipitates are produced by annealing, and hence attention has started to be paid to development of a rapidly solidified material in the form of a thin belt or the like having a larger shape-recovery performance.

However, an alloy having high performances as described above has been realized primarily by a thin belt or a thin wire having a thickness or a diameter of approximately 200 μm or less, and it has been difficult to obtain a material having predetermined properties by a melt method. Heretofore, as a method for producing a bulk crystalline alloy in the form of a plate, a bar, or the like having a thickness or a diameter in the order of millimeters or more, besides a melt method, a powder metallurgical method has been known. As one powder metallurgical method, a spark plasma sintering method has been known (for example, see Non-Patent Document 4 and Patent Document 6).

In the spark plasma sintering method, high energy pulses can be concentrated on positions at which intergranular bonds are intended to be formed, and hence a sintering process dynamically proceeds. This is the feature of the spark plasma sintering process and is significantly different from a general quasi-static sintering method such as hot pressing or resistance sintering. Since rapid temperature increase only on grain surfaces can be performed by self-heating, while the grain growth of a sintering raw material is suppressed, a dense sintered body can be obtained within a short period of time. In addition, since the texture inside the sintering raw material can be prevented from being changed, a powdered material having an amorphous structure or a nanocrystalline texture can be formed into a bulk shape such as a plate or a bar while maintaining its own structure or texture. By using this electrical spark plasma sintering method, a Fe—Dy—Tb-based or a rare earth element-transition metal-based giant magnetostrictive material formed into a desired shape has been developed (Patent Documents 7, 8, and 9).

Patent Document 1: Japanese Unexamined Patent Application Publication No. 1-212728 (Japanese Patent No. 2589125)

Patent Document 2: Japanese Unexamined Patent Application Publication No. 6-172886

Patent Document 3: Japanese Unexamined Patent Application Publication No. 11-269611

Patent Document 4: Japanese Unexamined Patent Application Publication No. 2003-96529

Patent Document 5: Japanese Unexamined Patent Application Publication No. 2003-286550

Patent Document 6: Japanese Unexamined Patent Application Publication No. 6-341292 (Japanese Patent No. 2762225)

Patent Document 7: Japanese Unexamined Patent Application Publication No. 5-105992

Patent Document 8: Japanese Unexamined Patent Application Publication No. 11-189853

Patent Document 9: Japanese Unexamined Patent Application Publication No. 2001-358377

Non-Patent Document 1: authored by Yasubumi Furuya, Chihiro Saito, and Teiko Okazaki, J. Japan Inst. Metals, vol. 66, pp. 901 to 904, (2002).

Non-Patent Document 2: authored by Yamahira, Shinya, Tamoto, Aiba, Kise, and Furuya, J. Japan Inst. Metals, vol. 66, No. 9, pp. 909 to 912, (2002).

Non-Patent Document 3: authored by C. Saito, Y. Furuya, T. Okazaki, T. Watanabe, T. Matsuzaki, and M. Wuttig, Mater. Trans., JIM, vol. 45, pp. 193 to 198, February (2004).

Non-Patent Document 4: authored by M. Omori, Mater. Sci. Eng. A, vol. 287, pp. 183 to 188, August (2000).

Non-Patent Document 5: authored by K. Yamazaki, S. Kajiwara, T. Kikuchi, Kogawa and S. Miyazaki, Proc. ICOMAT-2002, Jun. 235-249, (2002).

### DISCLOSURE OF INVENTION

### Problems to be Solved by the Invention

A rapidly solidified material produced by a liquid rapid solidification method has superior performance; however, because of restrictions by the rapid cooling process, the material thus obtained has a very small thickness or diameter such as a plate material having a thickness of approximately not more than 100 μm or a wire material having a diameter of approximately not more than 100 μm. In addition, the maximum length of the rapidly solidified material thus produced is approximately 2 m, and a material having a considerably large length is difficult to be produced. When the materials described above are used, an actuating force thereof as an actuator element is small, and the application of the materials is limited only to micromachines and small sensor devices. In addition, since superior properties because of a non-equilibrium phase and a fine crystalline texture peculiar to a rapidly solidified material disappear when it is annealed for a long period of time, the improvement in alloy properties by annealing is limited.

Heretofore, as for an iron-based Fe—Ga magnetostrictive alloy, development by a single crystal method was performed only in USA (by the Office of Naval Research, ONR), and a magnetostriction of 300 ppm was reported. However, the singly crystal method must be carried out under very severe operation conditions, and in addition, single crystal actuator and sensor materials are disadvantageously very expensive.

In addition, a Ti—Ni alloy has been well known as a temperature-sensitive shape-memory alloy and has been widely spread in industrial applications. Furthermore, it has been confirmed that when copper is added as a third element, hysteresis of the transformation point can be decreased. However, in a Ti—Ni alloy containing 8 atomic percent or more of copper, by a conventional processing method in which hot and cold rolling and drawing are repeatedly performed after melting, embrittlement occurs during material processing steps due to grain boundary segregation of Cu, and hence it is difficult to obtain thin wire and thin belt materials. As a result, the materials mentioned above become very expensive, and although the value-adding function thereof has been well known, the industrialization has been difficult as of today.

Accordingly, as a material used for actuator and sensor elements incorporated in mechanical and electronic components and in intelligent material systems and structures (aircrafts, automobiles, constructive structures, sonar devices, electric devices) of industrial application fields, development of bulk materials and that of production methods thereof have been desired, the bulk materials having workability to be formed into a complicated shape and having a large mass so as to obtain a large recovery force.

An object of the present invention is to produce a bulk material suitably used as a material for actuator and sensor elements from a Fe—Ga-based magnetostrictive alloy and/or a Ti—Ni-based shape-memory alloy taking advantage of crystal miniaturization and anisotropy as well as reduction in precipitates (equilibrium phase in state diagram) and non-equilibrium phases peculiar to liquid rapidly solidified materials, and to obtain performance enhancement by a production method superior to the melt method in terms of cost.

The present invention provides a bulk alloy having a mass to a certain extent while superior properties of a liquid rapidly solidified material are maintained. According to the present invention, a bulk alloy is formed by stacking slices in a die, which are formed from a rapidly solidified material having a particular rapidly solidified texture of a Fe—Ga magnetostrictive alloy or a Ti—Ni-based shape-memory alloy and superior properties based on the above texture, or filling a powder or chops of the rapidly solidified material in the die, followed by performing a spark plasma sintering method, so as to generate bonds between the slices, grains of the powder, or the chops at a high density. In addition, according to the present invention, the bulk alloy thus sintered is further annealed, so that the properties thereof are improved.

That is, the present invention is as follows:

(1) a rapidly solidified material consolidated into a bulk form for actuators and sensors, comprising a Fe—Ga magnetostrictive alloy which is obtained from slices, a powder or chops of a Fe—Ga alloy rapidly solidified material by spark plasma sintering, the Fe—Ga alloy rapidly solidified material having a high temperature-side disordered bcc structure and a fine columnar texture by a liquid rapid solidification method, being in a disordered to ordered transition composition range, and containing 15 to 23 atomic percent of Ga with respect to polycrystalline Fe;

(2) the rapidly solidified material consolidated into a bulk form for actuators and sensors, according to the above (1), wherein (001) crystalline anisotropy of a rapidly solidified thin belt of the Fe—Ga alloy is maintained;

(3) the rapidly solidified material consolidated into a bulk form for actuators and sensors, according to the above (1), wherein a magnetostriction of 170 to 230 ppm is obtained at room temperature by annealing following the sintering;

(4) the rapidly solidified material consolidated into a bulk form for actuators and sensors, according to the above (1), wherein a magnetostriction of 250 to 260 ppm is obtained at room temperature by annealing in a magnetic field following the sintering.

(5) a rapidly solidified material consolidated into a bulk form for actuators and sensors, comprising a TiNiCu shape-memory alloy which is obtained from slices, a powder or chops of a TiNiCu shape-memory alloy rapidly solidified material by spark plasma sintering, the TiNiCu shape-memory alloy rapidly solidified material being composed of an amorphous to nanocrystalline texture or an amorphous and nanocrystalline mixed texture by a liquid rapid solidification method;

(6) the rapidly solidified material consolidated into a bulk form for actuators and sensors, according to the above (5), wherein the TiNiCu shape-memory alloy is Ti₅₀₊ₓNi₄₀Cu₁₀₋ₓ (where x is in the range of 0 to 4 on an atomic percent basis);

(7) a method for producing the rapidly solidified material consolidated into a bulk form for actuators and sensors according to one of the above (1) to (4), comprising the steps of: forming a rapidly solidified material by a liquid rapid solidification method from a Fe—Ga alloy having a high temperature-side disordered bcc structure and a fine columnar texture, being in a disordered to an ordered transition composition range, and containing 15 to 23 atomic percent of Ga with respect to polycrystalline Fe; forming slices, a powder, or chops from the alloy as a raw material; and performing spark plasma sintering of the raw material at an application pressure of 50 MPa or more and at a sintering temperature of 873 K or more under conditions in which the pressure and the temperature are controlled so that the texture of the rapidly solidified material is not lost;

(8) a method for producing the rapidly solidified material consolidated into a bulk form for actuators and sensors according to the above (5) or (6), comprising the steps of: forming a TiNiCu shape-memory alloy rapidly solidified material which is composed of an amorphous to a nanocrystalline texture or an amorphous and nanocrystalline mixed texture by a liquid rapid solidification method; forming slices, a powder, or chops from the alloy as a raw material; and performing spark plasma sintering of the raw material at a temperature less than a recrystallization temperature of a TiNiCu shape-memory alloy;

(9) the method for producing a rapidly solidified material consolidated into a bulk form for actuators and sensors, according to the above (8), wherein the TiNiCu shape-memory alloy rapidly solidified material is wet-pulverized by rotary ball milling into slices, a powder, or chops;

(10) the method for producing a rapidly solidified material consolidated into a bulk form for actuators and sensors, according to the above (9), wherein the wet-pulverizing is performed using an alcohol;

(11) the method for producing a rapidly solidified material consolidated into a bulk form for actuators and sensors, according to one of the above (7) to (10), wherein annealing is performed after the sintering; and

(12) the method for producing a rapidly solidified material consolidated into a bulk form for actuators and sensors, according to the above (11), wherein the crystal orientation of alloy properties is enhanced by annealing in a magnetic field after the sintering, and the magnetic moment (magnetic domain structure) directly relating to the magnetostriction is controlled.

### ADVANTAGES

The new bulk rapidly solidified Fe—Ga magnetostrictive alloy according to the present invention can obtain approximately 80% of magnetostriction of a single crystalline magnetostrictive alloy, is significantly inexpensive (approximately one twentieth) as compared to the conventional rare earth-based Tefenol-D, and also has superior workability (ductility) and high rigidity. Accordingly, a rising strain energy density at an initial magnetization stage can be increased. In addition, the bulk Ti—Ni-based shape-memory alloy can be formed into a large bulk material having improved performances as compared to that of an arc melted and processed material used as a starting material, such as a narrow transformation point width and a high mechanical strength (hardness) 1.4 times or more than that of the arc melted and processed material. In addition, according to the method of the present invention, rapidly solidified materials can be formed into a bulk shape by a mass production process.

### BEST MODE FOR CARRYING OUT THE INVENTION

FIG. 1 shows steps of a method for producing a rapidly solidified material consolidated into a bulk form according to the present invention. A material for sensor and actuator elements is first formed by a liquid rapid solidification method. An ingot as a raw material is formed into a thin belt (ribbon) by a high-frequency induction melting-liquid rapid solidification method (twin roll or single roll quenching method). Alternatively, a thin wire (fiber) is formed by plasma arc melting-melt extraction rapid solidification method (conical-roll front-end spinning method). Accordingly, a rapidly solidified material having a fine columnar crystal texture, large crystalline anisotropy, and non-equilibrium phase and the like can be obtained.

A liquid rapid solidification method is frequently used as a method for producing an amorphous alloy and is also effectively used when a material having poor workability, such as a Fe—Ga magnetostrictive alloy or a Ti—Ni-based shape-memory alloy, is formed into a sheet having a thickness of 20 to 30 μm. In a liquid rapidly solidified alloy, because of crystal miniaturization having a nano- to micron-size scale and columnar crystal (anisotropy) formation, functional performances such as durability, ductility, magnetostrictive effect, and shape-memory effect can be improved.

Next, when the shape of a rapidly solidified material is a slice having a length of approximately 20 to 50 mm and a thickness of 20 to 30 μm, a perform is formed by stacking the slices in a die without pulverization and then can be sintered. When the shape of a rapidly solidified material is a long and thin belt, the material is cut to have a size approximately equivalent to that of the above slice to form a sintering raw material.

When a rapidly solidified material in the form of a thin belt or a thin wire is pulverized into a powder, wet pulverization is performed using rotary ball milling, that is, pulverization is performed while thin belts or thin wires are immersed in alcohol such as ethanol, so that a powder or chops are obtained. For the pulverization, a method using a planetary ball milling machine is preferable. This is a method in which a powder can be obtained within a short period of time by using centrifugal forces of balls and mechanical energy with a wall of a container.

A Fe—Ga magnetostrictive ally or a Ti—Ni base shape-memory alloy having a high hardness is difficult to be pulverized, and in particular, since a Ti—Ni base alloy is very hard, a considerable amount of energy is required for pulverization. Even when pulverization is performed, heat is generated thereby so as to enable an active Ti to cause reaction with surrounding impurities, moisture, and an oxidizing atmosphere, and as a result, the composition having shape-memory properties is changed. However, the inventors of the present invention found that when a wet pulverizing method using a high purity alcohol is employed, the change in atmosphere and the increase in heat can be suppressed, and hence the change in composition can also be suppressed.

Next, the powder or chops obtained by pulverization is filled in a die to form a preform. The sintering raw material laminated and placed in the die or that is filled therein is processed by spark plasma sintering. As shown in FIG. 2, the spark plasma sintering is performed by filling a sintering raw material 1 in a cemented carbide alloy die 2, and applying a pressure by pushing an upper punch 3 and a lower punch 4 therein. After those are fixed on a sintering stage (not shown) in a chamber 5, and the inside of the chamber 5 is evacuated by a vacuum pump 6, the sintering raw material 1 is sandwiched by an upper punch electrode 7 and a lower punch electrode 8, and pulse electricity is applied from a power source 9 while a pressure is being applied to the sintering raw material. A sintering temperature is controlled by a controller 11 while the temperature of the die 2 is being monitored by a thermocouple 10.

When pulse electricity is applied, a high speed diffusion effect is generated by high speed movement of ions caused by the electric field. By applying the voltage and the current repeatedly by this ON-OFF operation, since discharge points and Joule heat generation points (local high temperature-generation points) are moved in the sintering raw material and entirely distributed therein, the phenomenon and the effect obtained in the ON-state are uniformly repeated in the sintering raw material, and as a result, efficient sintering is performed in a solid phase with a small power consumption.

The case in which a Fe—Ga magnetostrictive alloy is produced by the above method will be described in more detail. In FIG. 3, as for a Fe—Ga alloy, the difference is shown between a thin belt material and a metal texture, the thin belt material being composed of a representative metastable phase (no precipitation phase) formed by a rapid solidification method, and the metal texture (Fe—Ga₃, LI₂, DO₃ ordered phase precipitation) being in accordance with a phase equilibrium diagram, which is obtained by performing general melting and processing, followed by annealing. The liquid rapidly solidified thin belt material is obtained as shown in FIG. 3 such that a molten metal 14 formed by heating and melting a raw material in a quartz crucible 12 by a high-frequency induction coil 13 is ejected by an Ar gas onto a high speed rotation surface of a rotary roll 15 to form a ribbon 6.

By the liquid rapid solidification method, a phase which generally appears only at a high temperature is first allowed to appear at room temperature by rapid solidification performed from a liquid phase. Second, at an intermediate cooling rate, a fine columnar crystal texture is formed. Since this texture is finer than a conventional polycrystalline material, it has a high strength, and since the thermal flow direction in solidification is along one axis, an anisotropic texture having strong orientation in that direction can be obtained. In a Fe—Ga alloy, when the magnetic anisotropy is controlled, a functional material having superior energy efficiency can be obtained.

In a Fe—Ga alloy, a Fe₁₀₀₋ₓGaₓ single crystal obtained by a general melting and processing method has a disordered bcc structure when x is 19 atomic percent or less, and the magnetostrictive constant is increased to 20 times that of Fe. Furthermore, when those single crystals are rapidly solidified from a high temperature, the magnetostrictive constant is further increased. However, it was reported that in an alloy in which x is 20 atomic percent or more, the magnetostrictive constant (saturated magnetostriction) is decreased (authored by T. A. Lograsso, A. R. Ross, D. L. Shlagel, A. E. Clark, and M. Wun-Fogel, “J. Alloys and Compounds” 35095-101 (2003)).

The change in the saturated magnetostriction of a Fe—Ga alloy with the change in composition will be described. According to the Ga concentration dependence of the magnetic moment per atom of a bcc Fe—Ga alloy (authored by N. Kawamiya, K. A. Adachi, and Y. Nakamura “J. Physics Soc. Japan. 33. 1218-1327, 1972), up to approximately 15 atomic percent of Ga, the change is as if Fe is simply diluted with Ga. At the Ga concentration more than the above, the change becomes different from the simple dilution behavior, and at a Ga concentration of 20 atomic percent or more, as the ordering proceeds, the magnetic moment is rapidly decreased. The reason for this is believed that when Fe is being surrounded by Ga, the magnetic moment of Fe itself is decreased. In addition, the ordered structure formation also begins to relate to the change in spontaneous magnetization.

Furthermore, according to the phase equilibrium diagram (not shown), the crystal structure is changed from a disordered bcc phase to ordered phases (DO3, L12) at approximately 700° C. in a region at a Ga concentration of 20 atomic percent or more, and hence it is believed that this structural change relates to the magnetostrictive value. Accordingly, when a high-temperature disordered bcc phase is frozen to room temperature by a liquid rapid solidification method without precipitating ordered phases of a Fe—Ga alloy, a larger magnetostriction can be expected.

Accordingly, it is important that alloy thin belts be formed by rapid solidification method and laminated to each other without performing any modification, followed by spark plasma sintering, the alloy thin belts having a high temperature-side disordered bcc structure and a fine columnar texture, those are not formed by a general melting and processing method, being in a disordered to ordered transition composition range, and containing 15 to 23 atomic percent of Ga with respect to polycrystalline Fe.

When the application forces by the upper and lower punches and the sintering temperature in spark plasma sintering are changed, the magnetic and magnetostrictive properties of a sintered material are changed. In order to complete the sintering while maintaining a fine crystal texture formed by the liquid rapid solidification method, it is preferable that in the spark plasma sintering, the pressure be increased as high as possible and that the sintering be performed at a low temperature. A Fe-17 at % Ga alloy thin belt can be sintered at an application pressure of 50 MPa or more and a sintering temperature of 873 K or more during spark plasma sintering. The ratio of the density of a sample sintered under 100 MPa at 973 K is approximately 100%.

When the material sintered under 100 MPa at 973 K was annealed for a short period of time, a magnetostriction of 170 to 230 ppm was obtained at room temperature. When annealing in a magnetic field is performed after sintering, the crystal orientation of the alloy properties can be enhanced, and in addition, the magnetic moment (magnetic domain structure) directly relating to the magnetostriction can be controlled. When the above sample was processed by annealing in a magnetic field after the sintering, the magnetostriction was increased to 250 to 260 ppm. The reason for this is believed that the magnetic (domains) structures which move and rotate and which are responsible for the magnetostriction generation mechanism are aligned in a magnetic field processing direction at a nano to a meso level, and as a result, the magnetic rotation is promoted at a micron level with respect to external magnetic field application, so that the magnetostriction is promoted.

From the results described above, it is preferable that in order to obtain a large magnetostriction, the texture peculiar to a liquid rapidly solidified thin belt be not changed, and in addition, in order to sufficiently bonds thin belts to each other, the application pressure and the sintering temperature be set to 50 MPa or more and 873 K or more, respectively. The upper limit of the application pressure and that of the sintering temperature must be determined so as not to lose the texture of the rapidly solidified material.

Besides the properties of the liquid rapidly solidified material before spark plasma sintering, pulverization conditions of the material also has influence on the properties of a bulk alloy. Alcohol-wet milling is effective to maintain the properties of a rapidly solidified material. In particular, since titanium is a very active element, it is preferable that titanium be prevented from reacting with oxygen in an atmosphere and/or carbon from a die during milling and discharge plasma sintering. When the reaction once occurs, the content of titanium in a Ti—Ni-based shape-memory alloy is decreased, and as a result, the transformation point tends to decrease lower than that of the original material.

In a spark plasma sintered bulk material formed from a pulverized material (powder, chops) in which the functional properties of a Ti—Ni rapidly solidified material were allowed to remain as much as possible, a thermoelastic phase transformation phenomenon could also be confirmed by DSC. In a Ti-rich TiNiCu base material, it was confirmed that a large bulk material having improved performances as compared to an arc melted and processed material used as a starting material, such as a narrow temperature transformation width and a high mechanical strength (hardness) approximately 1.5 times as large as that of the arc melted and processed material, can be obtained by spark plasma sintering (sintering conditions: sintering temperature of 873 K, and a pressure of 300 MPa) for bonding of thin belts which are placed in a ultra-rapidly rapidly solidified amorphous to nanocrystalline state.

A bulk material of Ti₅₀Ni₄₀Cu₁₀ having a 90% density can be obtained under spark plasma sintering conditions in which the pressure is set to a die limit pressure of 300 MPa, and in addition, under a temperature condition of 400° C. or more. This temperature condition is lower than a recrystallization temperature of the TiNiCu alloy of 600° C., and hence the rapidly solidified material is not recrystallized and maintains its fine crystal texture.

### EXAMPLE 1

A Fe-17 at % Ga alloy ingot was formed by melting electrolytic iron and Ga by a plasma arc melting method. This ingot was melt and was formed into a thin belt 2 m long, 5 mm wide, and 80 μm thick in an argon atmosphere by a liquid rapid solidification (single roll) method. This thin belt was cut into slices 40 mm long to be used for a discharge plasma sintering sample.

After 300 slices were stacked together in a cemented carbide alloy die, sintering was performed for Sample (a) under 50 MPa at 973 K, Sample (b) under 100 MPa at 973 K, and Sample (c) under 300 MPa at 873 K, and the sintering time was set to 5 minutes. As a spark plasma sintering apparatus, SPS 1050 manufactured by Sumitomo Coal Mining Co., Ltd. was used. The spark plasma sintering was performed at a vacuum degree of 2 Pa, a current of 3,000 A, and a voltage of 200 V. The temperature rising conditions were different depending on the temperature; however, it was approximately 30 minutes. The size of the sample after the sintering was 40 mm long, 5 mm wide, and 9 mm thick (in the direction perpendicular to the surface of the thin belt). For comparison purposes, a sample (equivalent to that described in Non-Patent Document 2) was prepared which was obtained by annealing an as-rapidly-solidified Fe-15 at % Ga alloy thin belt at 1,173 K for 0.5 hours.

<X-Ray Structure Analysis>

The analysis of the crystal structure of each sintered sample was performed by analyzing the peak of the CuKal line using an X-ray diffraction method. FIG. 4 shows X-ray diffraction patterns of Samples (a), (b) and (c), which were the sintered samples of the Fe-17 at % Ga alloy, and Sample (d) of a comparative example. The three types of sintered samples are formed of a body-centered cubic structure having a lattice constant of 0.2904 nm. The intensity of the (200) peak of Sample (b), the sample sintered under 100 MPa at 973 K, is strong as compared to that of the other sintered samples and is similar to the diffraction pattern of Sample (d) of the comparative example having a strong [100] orientation. This result indicates that in Sample (b), the [100] texture of the thin belt is maintained.

Since Sample (a), the sample sintered under 50 MPa at 973 K, has the (200) peak although it is weaker than that of Sample (b), the sample sintered under 100 MPa at 973 K, the texture is maintained. On the other hand, the (200) peak of Sample (c), the sample sintered under 300 MPa at 873 K, is small and spread, and hence the texture of the thin belt is lost. The reason for this is believed that an application pressure of 300 MPa causes plastic deformation and internal damage.

<Magnetization and Magnetostriction Measurement>

For the magnetization measurement, by using a vibrating sample magnetometer (VSM), a magnetization-magnetic field hysteresis curve (M-H loop) was measured at a maximum magnetic field of 10 kOe. Furthermore, as shown in FIG. 5, by using a measurement device formed of 2 brass plates 18, brass screws 19, and an acrylic resin 20, strain gauges 17 were adhered to a sample 21, and the magnetostriction parallel to the thickness direction was measured.

A compressive stress of 20 MPa, 60 MPa, or 100 MPa was applied to the sample as a pre-stress, and the magnetostrictive value was determined by the average of the values obtained by the strain gauges 17 provided on the front and the rear surface of the sample. For the magnetization and the magnetostriction measurement, a Fe-17 at % Ga alloy sintered sample was cut to have a length of 2.7 mm, a width of 5 mm, and a thickness (in the direction perpendicular to the surface of the thin belt) of 9 mm. Since it has been reported (Non-Patent Document 2) that when a magnetic filed is applied perpendicularly to the surface of a thin belt, a large magnetostriction is obtained, a magnetic field H was applied in the direction as described above also in this example. The saturated magnetization was 1.68 Tesla and was hardly changed even when the pre-stress was changed.

FIG. 6 shows the magnetostriction of Sample (b), which is the sample sintered under 100 MPa at 973 K. The magnetostriction considerably depends on a pre-stress s, is saturated at a low magnetic field of 2 kOe, and is then slightly decreased to the original value as H is increased. A maximum magnetostriction of 100 ppm was obtained when a pre-stress s of 100 MPa was applied. The maximum magnetostriction of Sample (a), the sample sintered under 50 MPa at 973 K, was 70 ppm and was smaller than that of Sample (b), which is the sample sintered under 100 MPa at 973 K. The reason for this is believed that since the stress in sintering was excessively small, bonds between the thin belts were not sufficiently formed. Furthermore, since Sample (c), the sample sintered under 300 MPa at 873 K, had a random texture, the magnetostriction thereof was smallest.

### EXAMPLE 2

Sample (b), the sample sintered under 100 MPa at 973 K, produced by the method described in Example 1 was annealed at 1,173 K for 1 hour in a vacuum atmosphere. After the annealing, the magnetostriction was measured. FIG. 7 is a graph showing the magnetostrictions of the sintered sample before and after the annealing. The magnetostrictions before and after the annealing at H of 2 kOe were 100 ppm and 170 to 230 ppm, respectively, and it was found that the magnetostriction was increased by the annealing. Furthermore, when annealing in a magnetic field was performed after the sintering, the magnetostriction was increased to 250 to 260 ppm. The reason the magnetostriction is increased when the thin belt sample is annealed for a short period of time is believed that the [100] orientation is enhanced so that the magnetostriction is increased [see Non-Patent Document 2], and in addition, it is also believed that the magnetic moments (magnetic domain structures) directly relating to the magnetostriction which are aligned in a specific direction by application of an external magnetic field also relate to this increase in magnetostriction.

### EXAMPLE 3

[Example of TiNiCu Shape-Memory Alloy]

Materials were weighed so as to have a composition of Ti₅₀Ni₄₀Cu₁₀ (atomic percent) and were then formed into alloy ingots as a raw material by a plasma arc melting method in an argon atmosphere. Subsequently, from the ingots thus formed, a thin belt (ribbon) was formed by a high frequency induction melting-liquid rapid solidification method (twin roll quenching method), and a thin wire (fiber) was formed by plasma arc melting-melt extraction rapid solidification method (conical-roll front-end spinning method), so that rapidly solidified materials were obtained. The rapidly solidified materials were wet-pulverized (in ethanol having a purity of 99.99%) by ball milling, so that Example A (ribbon) and Example B (fiber) were obtained. In addition, pulverization was performed in a dry atmosphere (in the air), so that Comparative example A (ribbon) and Comparative example B (fiber) were obtained.

<Alloy Properties of Material after Pulverization>

The DSC change with the milling time of the material was investigated. In addition, the milled states and crystal boundaries were observed by a scanning laser microscope. When the transformation points of the rapidly solidified thin wire and thin belt, which were milled to a powdered state (Comparative example A) in the air, were measured with time, it was found that when the thin belt was milled only for 5 minutes, the shape-memory effect was substantially lost. Furthermore, when the milling was performed for 55 minutes, the transformation point could not be observed at all. The reason for this is construed as follows. Since a Ti—Ni base alloy has poor workability, when the number of rotations is increased to form a powder, heat is generated by bombardment during milling, and as a result, the crystal structure and/or the composition ratio of the material is degraded.

The transformation point of the material which was milled in liquid ethanol (examples) not in the air was measured with time. The results are shown in Table 1. Although the decrease in shape-memory properties is observed to a certain extent thereby, when alloy properties after consolidating into a bulk form using powdered materials obtained by wet milling are compared, the decrease in shape-memory properties is not so much observed.

FIG. 8 is the DSC measurement performed with the wet milling time. From this figure, although the peak is decreased as compared to the original material, the transformation point tends to remain. The reason for this is believed that the increase in temperature in the mill is suppressed by the presence of ethanol.

<Alloy Properties of Spark Plasma Sintered Bulk Material>

The powders obtained by the above methods were processed by bulk solidification using a spark plasma sintering method in a manner equivalent to that in Example 1 while low temperature-side short-time sintering conditions were changed. The spark plasma sintering bulk formation conditions are shown in Table 1. Furthermore, the obtained samples were annealed at 673 K for 30 minutes in a vacuum atmosphere.

TABLE 1

| | Comparative | Comparative | | |
|---|---|---|---|---|
| | Example A | Example B | Example A | Example B |
| Material shape | Ribbon | Fiber | Ribbon | Fiber |
| Quenched material | Twin roll | Melt extraction | Twin roll | Melt extraction |
| formation method | | | | |
| Milling method | in Air | in Air | in Ethanol | in Ethanol |
| Milling (Time) | Total 55 min. | Total 80 min. | Total 60 min. | Total 87 min. |
| (Number of | 230 rpm | 120-150 rpm | 250 rpm | 160-220 rpm |
| Rotations) | | | | |
| SPS pressure | 0.72 ton | 10 ton | 10.04 ton | 1.44 ton |
| condition | | | | |
| SPS temperature | 1,000° C. | 600° C. | 600° C. | 1,000° C. |
| condition | | | | |
| Holding time | 10 min. | 10 min. | 5 min. | 10 min. |
| Bulk formation | Yes | Yes | Yes | Yes |
| Die material | C die (oval) | WC + Co die | WC + Co die | C die (oval) |
| Transformation | No | Present | Present | Present |
| point | | | | |
| Ms − Mf | No | <68.1> − <75.6> | <−16.5> − <50.3> | <34.3> − <56.6> |
| temperature (° C.) | | | | |
| As − Af | No | <54.1> − <62.9> | <36.7> − <−27.9> | <41.5> − <7.4> |
| temperature (° C.) | | | | |

Whether the formed bulk shape-memory alloy samples showed a shape-memory effect was confirmed by differential thermal decomposition (DSC), and as for the sample which showed a shape-memory effect, the transformation point thereof was measured. The fiber had a sharp and narrow peak of the DSC curve showing the transformation point as compared to that of the ribbon, and this indicates that the fiber has superior response properties. The reason for this is believed that since the fiber has superior pulverization properties, even when the number of rotation is decreased, a powdered material can be obtained which maintains alloy properties of the rapidly solidified material. As for this spark plasma sintered bulk TiNiCu sample having clear phase transformation observed by DSC, the shape-recovery phenomenon was confirmed concomitant with the increase in temperature.

### EXAMPLE 4

Materials were weighed so as to obtain a composition of Ti₅₄Ni₄₀Cu₆ (atomic percent) and were then formed into a plasma arc melted alloy in an argon atmosphere. This alloy was placed in a quartz tube and was melted by induction heating, followed by formation of a ribbon-shaped sample by using a liquid rapid solidification apparatus in an argon atmosphere. The surface velocity of a rotary roll was increased to the maximum (˜5,430 rpm, a surface velocity Vr of 45 m/s or more).

The crystal structure of the sample thus formed was measured by X-ray diffraction, Tc and the transformation point were measured by a differential scanning calorimeter (DSC), and properties evaluation such as a tensile test and the like was performed. In addition, the ribbon used for the transformation point measurement was a ribbon which was quenched at Tc for 1 hour. It was confirmed that the ribbon was changed so as to have an amorphous structure.

Subsequently, about 50 thin ribbons which were approximately in an amorphous state were stacked together in a die (having a length of 40 mm and a width of 3 mm) and were processed by bulk solidification in accordance with a spark plasma sintering method in an argon atmosphere. As the sintering conditions, the sintering temperature, the pressure inside the chamber, and the holding time were 873 K, 300 MPa, and 5 minutes, respectively. In order to preferentially obtain the bonds between the ribbons, the sintering was performed at a die temperature limit higher than the crystallization temperature. The density of the bulk-solidified sample was approximately 95%, and hence the bonding by the sintering was confirmed.

FIG. 9 shows X-ray diffraction results of the Ti-rich TiNiCu alloy amorphous ribbon in an as-rapidly-solidified state and the spark plasma sintered bulk solidified material. In addition, in FIG. 10, the DSC measurement results of the spark plasma sintered bulk solidified materials are shown which were formed from the rapidly solidified Ti-rich TiNiCu amorphous alloy ribbon. It was confirmed that the sample of the bulk solidified material is crystallized at a time at which it is sintered by the spark plasma sintering. Furthermore, it was also confirmed that the transformation point of the bulk solidified material before annealing is higher than that of the ribbon. The reason for this is believed that although the transformation point is decreased by a compressive residual stress concomitant with the rapid solidification, the stress was released by the temperature condition in the spark plasma sintering, and as a result the transformation point is increased.

The change in mechanical strength (hardness) of the bulk solidified material thus formed was investigated. The bulk solidified material had a length of 40 mm, a width of 3 mm, and a thickness of 500 μm (approximately 50 times that of the original rapidly solidified material). As for the Vickers hardness, the measurement of the bulk solidified material after the spark plasma sintering was performed after the temperature was increased to a temperature range of a stable austenite (A) phase which was not less than the reverse transformation (Af) point of an arc melted alloy of an comparative example, and as a result, a hardness 1.45 times that of the arc melted alloy was obtained, so that it was confirmed that bonding was performed by the spark plasma sintering and that the strength improvement effect by rapid solidification was maintained. The measurement results are shown in Table 2.

TABLE 2

| | Arc melted alloy | Bulk solidified alloy |
|---|---|---|
| 283(K) | HV = 689.7 | HV = 681.3 |
| 353(K) | HV = 1,366.8 | HV = 1,988.8 |

### INDUSTRIAL APPLICABILITY

As for application of the rapidly solidified materials consolidated into a bulk form of the present invention as a magnetostrictive material, magnetic sensors and magnetostrictive actuators (drive devices) are typically mentioned. As particular examples of the actuator sensors made from the magnetostrictive material, for example, a submerged sonar device (sound locator), fish detector, active damping device, acoustic speaker, engine fuel injection valve, electromagnetic brake, micro-positioner, fluid control (gas and liquid) valve, electric toothbrush, vibrator, and dental cutting and vibrating therapeutic device may be mentioned, and in addition, an automobile torque sensor, electric automobile torque sensor, sensor shaft, strain sensor, security sensor and the like may also be mentioned. Besides, there have been developed insulated magnetic particles and silicon steel to overcome an eddy-current loss in dynamic operation of a magnetostrictive material, and magnetostrictive composite materials using a non-electric conductive material.

On the other hand, as application of the bulk shape-memory TiNiCu alloy which is the rapidly solidified material consolidated into a bulk form of the present invention, since high response properties and high mechanical strength can be obtained, various applications may be developed. For example, there may be mentioned a temperature-sensitive actuator, hothouse window operating device, air-conditioner flap, swing-wing of aircraft for high-efficiency flight, steam valve of rice cooker, hot-water control valve, fluid control valve, rock pulverizer, micro-machine drive device, endoscope holder, biomedical material (artificial dental tooth, bone alternative material, orthodontic wire), various underwear core materials, shoulder pad core, medical-bed core material for prevention of pressure sore by using a superelastic function, patient wearing medical device, and antenna core material of mobile phone. In addition, by using high recovery forces and high rigidity (rigidity change) in heating of a shape-memory alloy, various applications, such as intelligent composite materials (vehicle structural material, building wall, and bridge floor material) for controlling and suppressing vibration, and supporting pillar (beam) materials for connecting between frames of machines and structures to control the vibration thereof may be developed.

### BRIEF DESCRIPTION OF THE DRAWINGS

FIG. 1 is a flowchart of a method for producing a rapidly solidified material consolidated into a bulk form according to the present invention.

FIG. 2 is a schematic view of a spark plasma sintering apparatus.

FIG. 3 is a schematic view showing the difference of a Fe—Ga magnetostrictive alloy texture between a rapidly solidified thin belt material composed of a non-equilibrium phase and a heat-treated material composed of an equilibrium phase after melt processing.

FIG. 4 includes x-ray diffraction patterns of a Fe-17 at % Ga alloy sintered sample and a Fe-15 at % Ga thin-belt alloy sample.

FIG. 5 is a schematic view showing a magnetostriction measurement method.

FIG. 6 is a graph showing the magnetostriction (compressive strength a dependence) of a Fe-17 at % Ga alloy sintered (under 100 MPa at 973 K) sample and a magnetostrictive increase phenomenon after annealing.

FIG. 7 is a graph showing a magnetostrictive increase phenomenon (shown by black squares, at a compressive stress σ=100 MPa) after annealing of a Fe-17 at % Ga alloy sintered (under 100 MPa at 973 K) sample, followed by annealing in a magnetic field (400° C., H=0.5 Tesla, 15 minutes).

FIG. 8 is a graph showing DSC measurement results of a TiNiCu alloy with time of wet milling.

FIG. 9 includes x-ray diffraction patterns of a Ti-rich TiNiCu alloy material in an as-rapidly solidified state and of spark plasma sintered bulk solidified materials.

FIG. 10 is a graph showing DSC measurement results of a spark plasma sintered bulk solidified material of a rapidly solidified Ti-rich TiNiCu alloy.

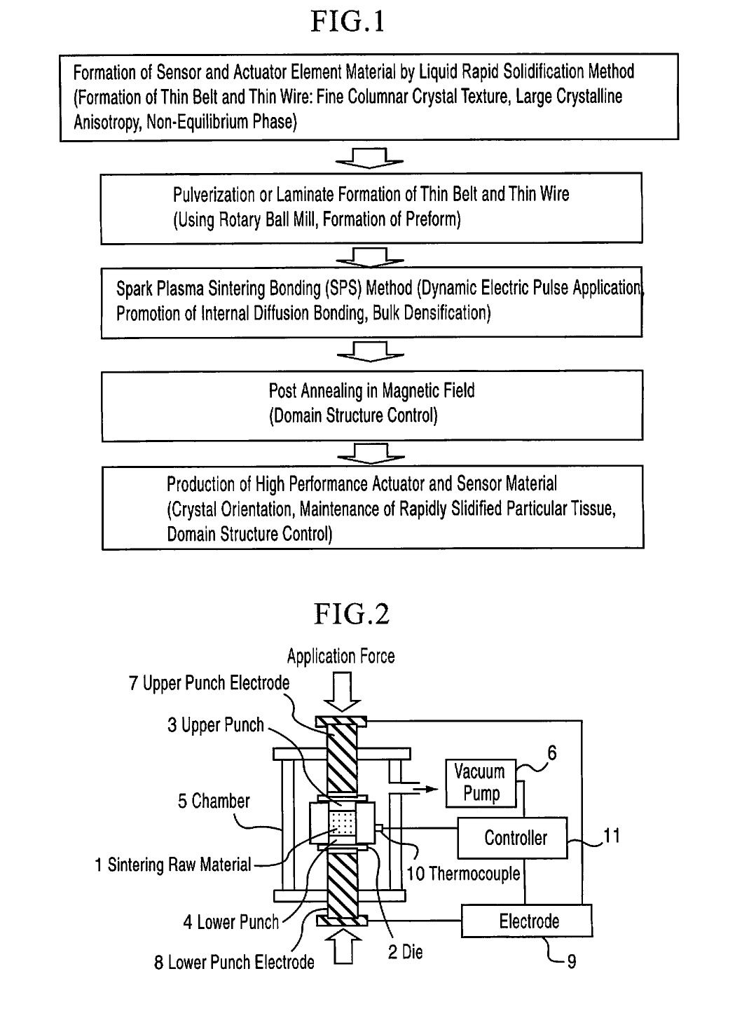

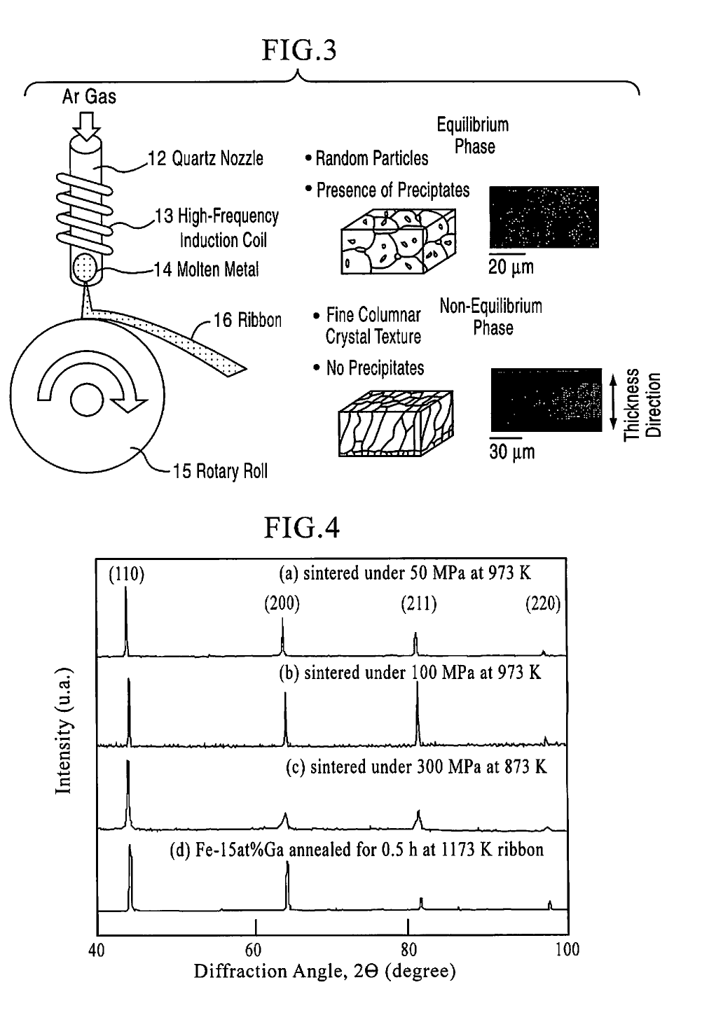

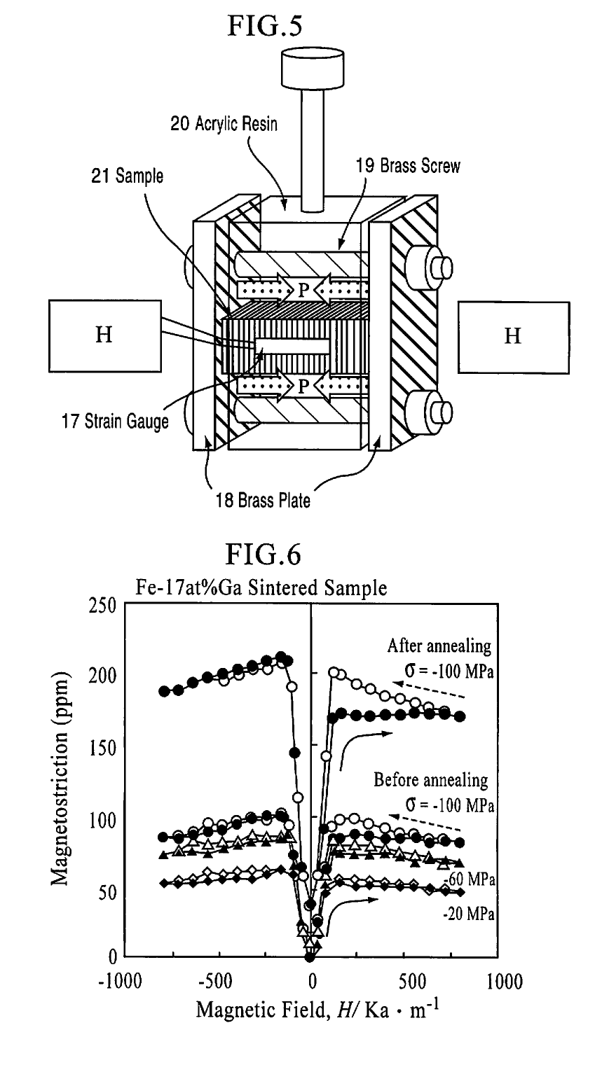

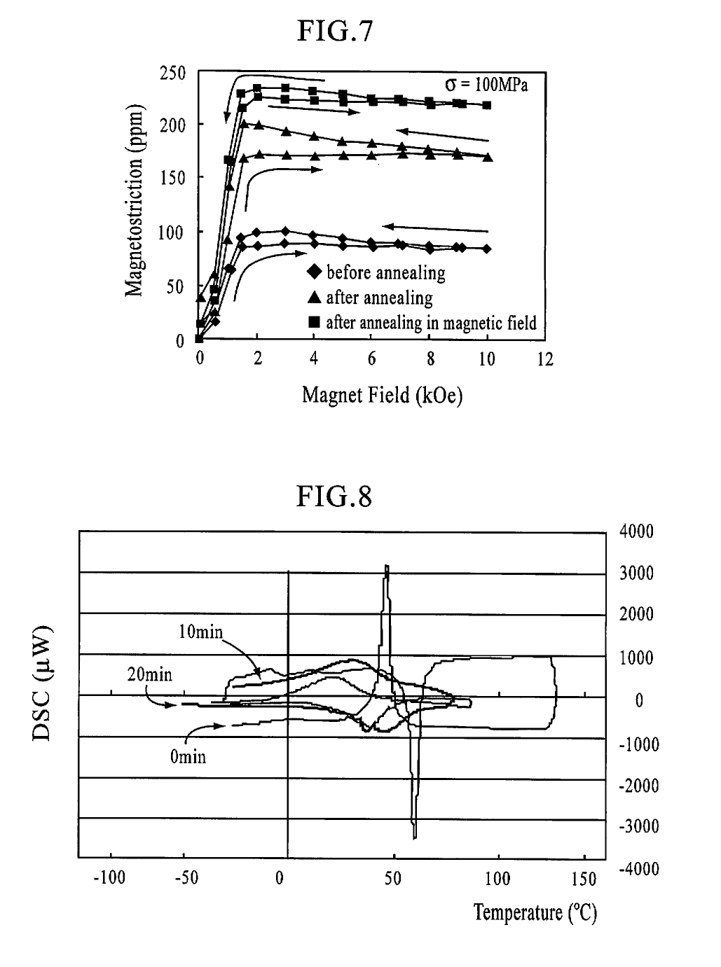

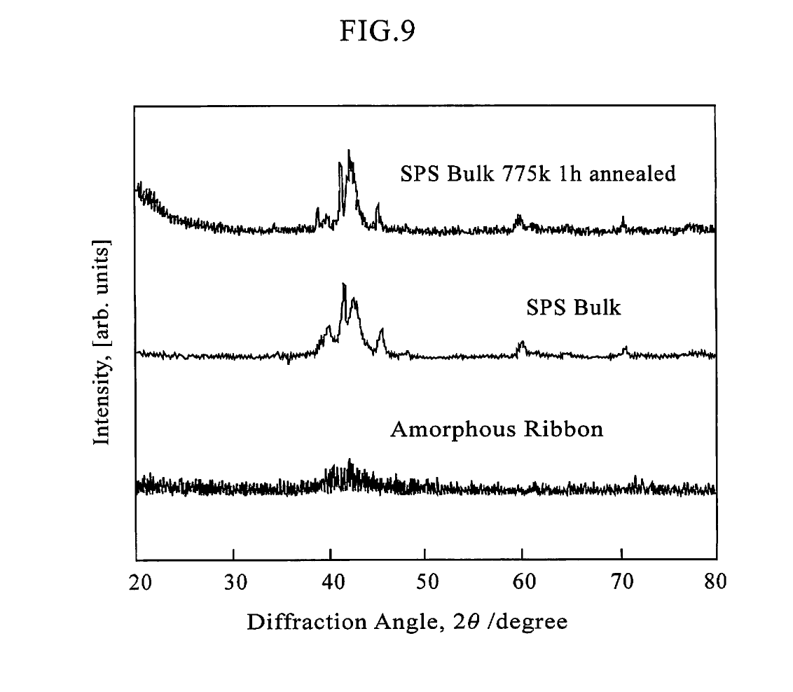

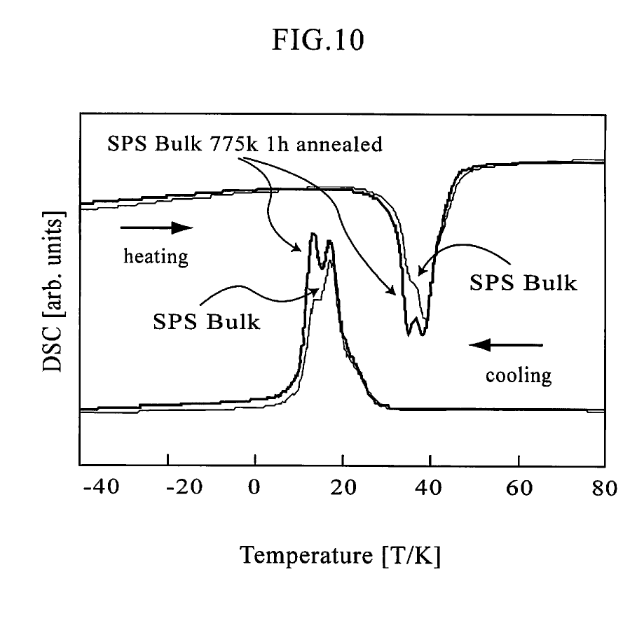

1. A rapidly solidified material consolidated into a bulk form for actuators and sensors, comprising a Fe—Ga magnetostrictive alloy which is obtained from slices, a powder or chops of a Fe—Ga alloy rapidly solidified material by spark plasma sintering, the Fe—Ga alloy rapidly solidified material having a high temperature-side disordered bcc structure and a fine columnar texture by a liquid rapid solidification method, being in a disordered to ordered transition composition range, and containing 15 to 23 atomic percent of Ga with respect to polycrystalline Fe.

2. The rapidly solidified material consolidated into a bulk form for actuators and sensors, according to claim 1, wherein (001) crystalline anisotropy of a rapidly solidified thin belt of the Fe—Ga alloy is maintained.

3. The rapidly solidified material consolidated into a bulk form for actuators and sensors, according to claim 1, wherein a magnetostriction of 170 to 230 ppm is obtained at room temperature by annealing following the sintering.

4. The rapidly solidified material consolidated into a bulk form for actuators and sensors, according to claim 1, wherein a magnetostriction of 250 to 260 ppm is obtained at room temperature by annealing in a magnetic field following the sintering.

5. A rapidly solidified material consolidated into a bulk form for actuators and sensors, comprising a TiNiCu shape-memory alloy which is obtained from slices, a powder or chops of a TiNiCu shape-memory alloy rapidly solidified material by spark plasma sintering, the TiNiCu shape-memory alloy rapidly solidified material being composed of an amorphous to nanocrystalline texture or an amorphous and nanocrystalline mixed texture by a liquid rapid solidification method.

6. The rapidly solidified material consolidated into a bulk form for actuators and sensors, according to claim 5, wherein the TiNiCu shape-memory alloy is Ti₅₀₊ₓNi₄₀Cu₁₀₋ₓ (where x is in the range of 0 to 4 on an atomic percent basis).

7. A method for producing the rapidly solidified material consolidated into a bulk form for actuators and sensors according to claim 1, comprising the steps of: forming a rapidly solidified material by a liquid rapid solidification method from a Fe—Ga alloy having a high temperature-side disordered bcc structure and a fine columnar texture, being in a disordered to an ordered transition composition range, and containing 15 to 23 atomic percent of Ga with respect to polycrystalline Fe; forming slices, a powder, or chops from the alloy as a raw material; and performing spark plasma sintering of the raw material at an application pressure of 50 MPa or more and at a sintering temperature of 873 K or more under conditions in which the pressure and the temperature are controlled so that the texture of the rapidly solidified material is not lost.

8. A method for producing the rapidly solidified material consolidated into a bulk form for actuators and sensors according to claim 5, comprising the steps of: forming a TiNiCu shape-memory alloy rapidly solidified material which is composed of an amorphous to a nanocrystalline texture or an amorphous and nanocrystalline mixed texture by a liquid rapid solidification method; forming slices, a powder, or chops from the alloy as a raw material; and performing spark plasma sintering of the raw material at a temperature less than a recrystallization temperature of a TiNiCu shape-memory alloy.

9. The method for producing a rapidly solidified material consolidated into a bulk form for actuators and sensors, according to claim 8, wherein the TiNiCu shape-memory alloy rapidly solidified material is wet-pulverized by rotary ball milling into slices, a powder, or chops.

10. The method for producing a rapidly solidified material consolidated into a bulk form for actuators and sensors, according to claim 9, wherein the wet-pulverizing is performed using an alcohol.

11. The method for producing a rapidly solidified material consolidated into a bulk form for actuators and sensors, according to claim 8, wherein annealing is performed after the sintering.

12. The method for producing a rapidly solidified material consolidated into a bulk form for actuators and sensors, according to claim 11, wherein the crystal orientation of alloy properties is enhanced by annealing in a magnetic field after the sintering, and the magnetic moment (magnetic domain structure) directly relating to the magnetostriction is controlled.
